(19) United States
(12) Patent Application Publication
(10) Pub. No.: US 2011/0062799 A1
(43) Pub. Date: Mar. 17, 2011

(54) STATOR ASSEMBLING MECHANISM OF LINEAR MOTOR THAT IS ADAPTED TO AUTOMATED ASSEMBLING PROCESS

(76) Inventors: Chih-Hsien CHAO, Taichung City (TW); Fu-Yuan Cheng, Taichung City (TW)

(21) Appl. No.: 12/558,792

(22) Filed: Sep. 14, 2009

(51) Int. Cl. H02K 41/03

(52) U.S. Cl. 310/12.02

(57) ABSTRACT

A stator assembling mechanism of linear motor that is adapted to automated assembling process, including a sleeve, several magnetic members and two end pieces. The sleeve includes a straight tubular body having two axial ends each having an opening. The magnetic members are sequentially axially arranged in the straight tubular body with the magnetic poles of the same polarity adjacent to each other. Each end piece has a main body formed with a threaded section for screw-connecting with one axial end of the straight tubular body so as to block the openings thereof and restrict the magnetic members within the sleeve. A driven section is disposed at one end of the main body. Via the driven section, an external power device can drive the main body to screw-connect the threaded section with the axial end of the straight tubular body so as to connect the end piece with the sleeve.

### BACKGROUND OF THE INVENTION

The present invention relates generally to a driving technique, and more particularly to a stator assembling mechanism of linear motor that is adapted to automated assembling process.

FIGS. 1 and 2 show a conventional linear motor stator structure 1. The linear motor stator structure 1 includes a threaded rod 3 and multiple magnetic rings 2 coaxially fitted on the threaded rod 3 to repel each other. Two threaded retaining collars 4 are screwed on two ends of the threaded rod 3 to tighten and locate the magnetic rings 2 on the threaded rod 3. Then an outer sleeve 5 is coaxially fitted around the magnetic rings 2 and two end caps 6 are plugged into two ends of the outer sleeve 5 to bind the magnetic rings 2 together so as to form the stator of the linear motor.

The conventional linear motor stator structure is composed of numerous components. When assembled, the magnetic rings 2 must be first fixed on the threaded rod 3 and then the end caps 6 and outer sleeve 5 are connected to enclose the magnetic rings 2 and threaded rod 3. Accordingly, the assembling process includes at least two steps, which cannot be completed by the same processing machine. Moreover, conventionally, in the first assembling step, the magnetic rings 2 are assembled with the threaded rod 3 artificially. The magnetic rings are arranged with the magnetic poles of the same polarity adjacent to each other. It costs much labor to overcome the strong repelling force between the adjacent magnetic rings. Therefore, the production efficiency can be hardly promoted. Also, after the first processing step is completed, the end caps 6 and the outer sleeve 5 must be further connected to bind the magnetic rings together in the second processing step. The second processing step can be completed under the assistance of a mechanical apparatus. However, due to the low efficiency of the first processing step, the assembling process still cannot be completed efficiently.

### SUMMARY OF THE INVENTION

It is therefore a primary object of the present invention to provide a stator assembling mechanism of linear motor that is adapted to automated assembling process. With the linear motor stator assembling mechanism, the linear motor stator can be assembled by one single process so that the manufacturing cost is lowered.

It is a further object of the present invention to provide the above stator assembling mechanism of linear motor, which makes it easier to assemble the linear motor state and makes it possible to automate the assembling process of the linear motor stator. Therefore, the production efficiency of the linear motor stator can be enhanced.

To achieve the above and other objects, the stator assembling mechanism of linear motor that is adapted to automated assembling process of the present invention includes a sleeve, several magnetic members and two end pieces. The sleeve includes a straight tubular body having two axial ends each having an opening. The magnetic members are sequentially axially arranged in the straight tubular body with the magnetic poles of the same polarity adjacent to each other. Each end piece has a main body formed with a threaded section for screw-connecting with one axial end of the straight tubular body so as to block the openings thereof and restrict the magnetic members within the sleeve. A driven section is disposed at one end of the main body. Via the driven section, an external power device can drive the main body to screw-connect the threaded section with the axial end of the straight tubular body so as to connect the end piece with the sleeve.

The present invention can be best understood through the following description and accompanying drawings wherein:

### BRIEF DESCRIPTION OF THE DRAWINGS

FIG. 1 is a perspective exploded view of a conventional linear motor stator structure;

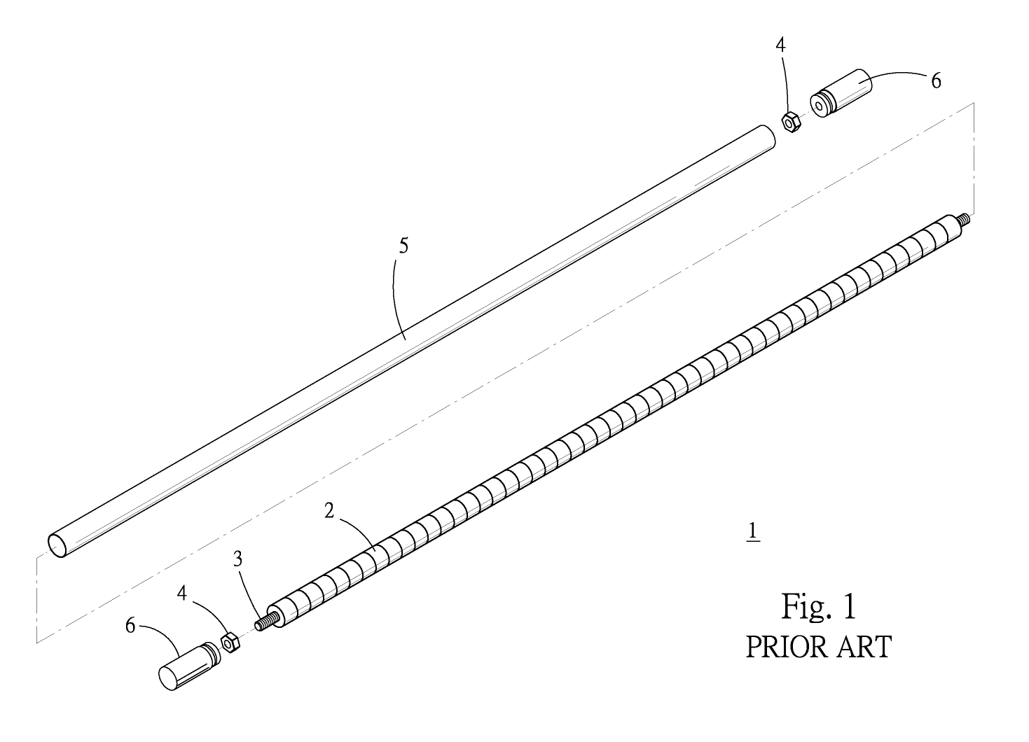

FIG. 2 is a sectional view of the conventional linear motor stator structure;

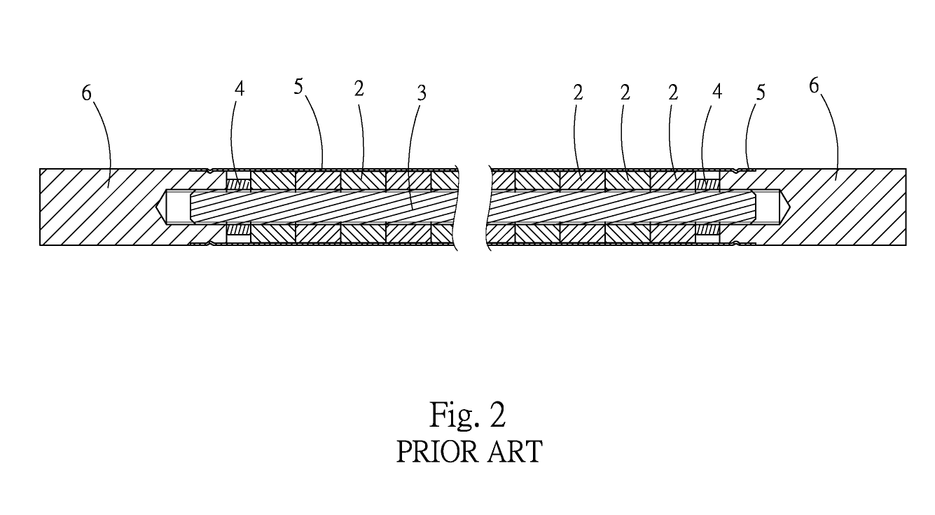

FIG. 3 is a perspective exploded view of a first embodiment of the present invention;

FIG. 4 is a perspective assembled view of the first embodiment of the present invention;

FIG. 5 is a perspective view of the end piece of the first embodiment of the present invention;

FIG. 6 is a sectional view of a part of the first embodiment of the present invention;

FIG. 7 is a perspective view showing the assembling process of the first embodiment of the present invention; and

FIG. 8 is a perspective view showing different end pieces of other embodiments of the present invention.

### DETAILED DESCRIPTION OF THE PREFERRED EMBODIMENTS

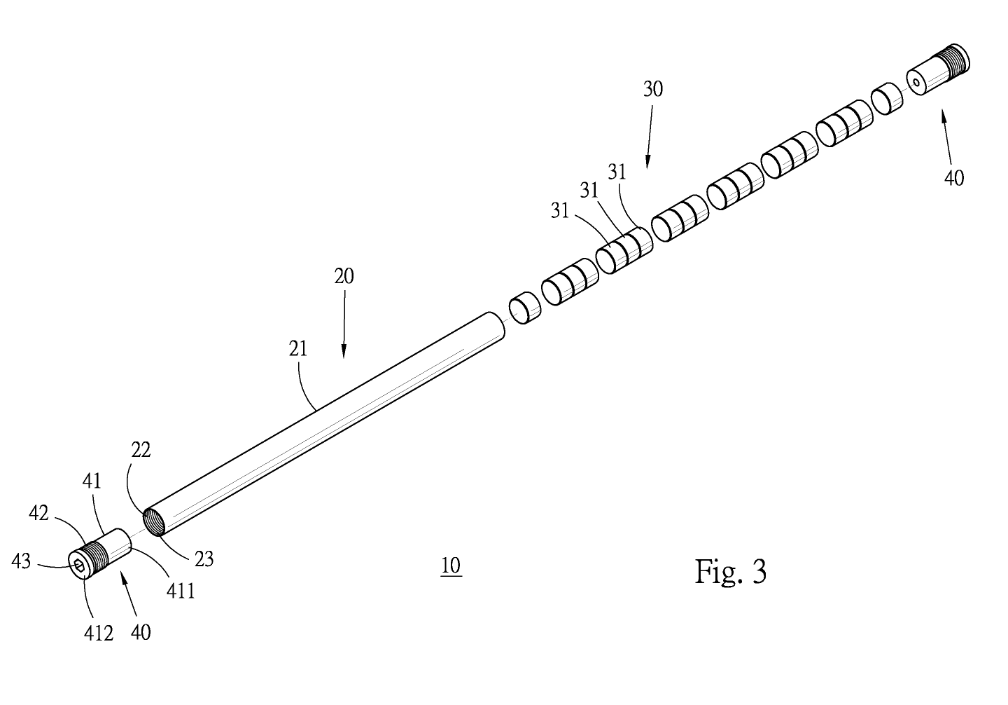

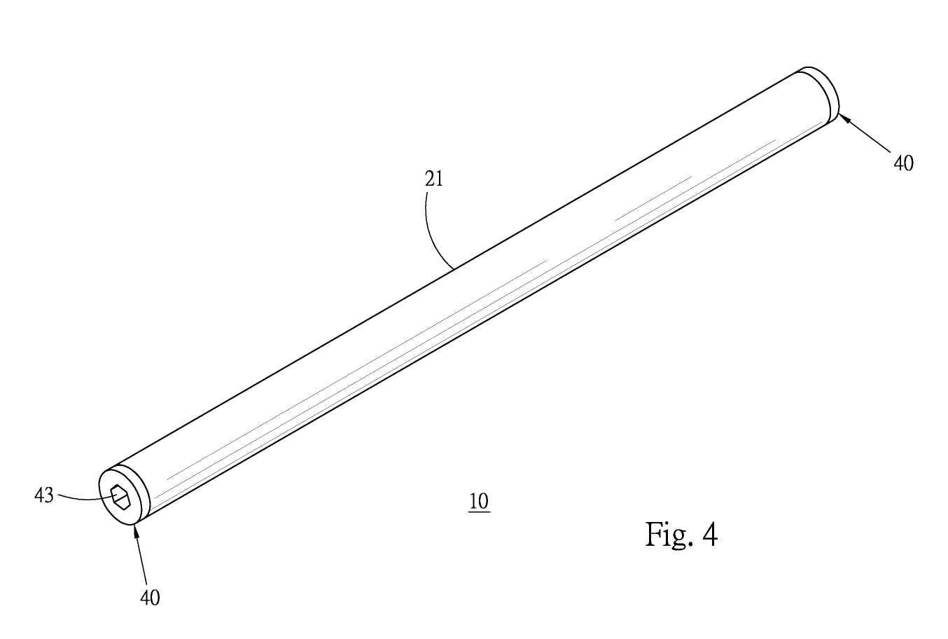

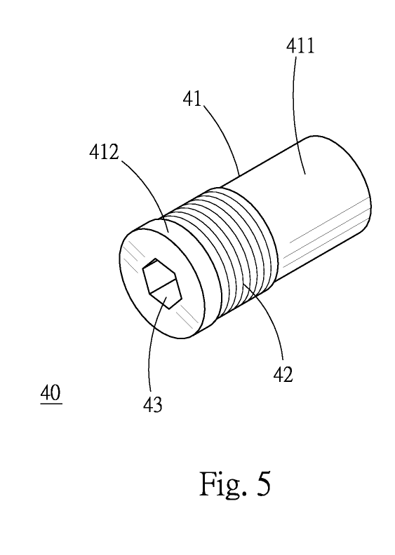

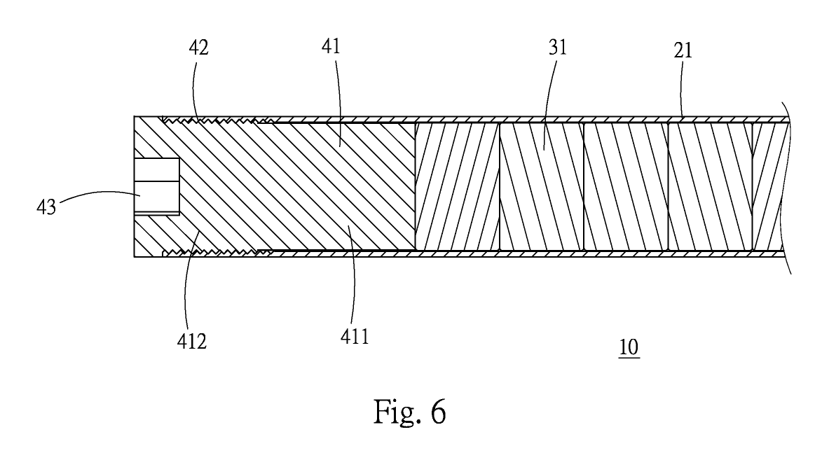

Please refer to FIGS. 3 to 7. According to a first embodiment, the stator assembling mechanism 10 of linear motor that is adapted to automated assembling process of the present invention includes a sleeve 20, multiple magnetic members 30 and two end pieces 40.

The sleeve 20 includes a straight tubular body 21 with a certain length. The straight tubular body 21 has two axial ends each having an opening 22 in communication with internal space of the straight tubular body 21 and outer side thereof. Two inner threads 23 are respectively annularly formed on wall faces of the openings 22 of two ends of the straight tubular body 21.

The magnetic members 30 are sequentially serially arranged and received in the internal space of the straight tubular body 21 along an axis thereof with the magnetic poles of the same polarity adjacent to each other. Each magnetic member 30 includes three magnetic bodies 31, which are serially arranged with the magnetic poles of different polarities adjacent to each other to attract each other.

Each end piece 40 has a columnar main body 41. The main body 41 has a first section 411 directed to a first axial end of the main body 41 and a second section 412 directed to a second axial end of the main body 41. The first section 411 has an outer diameter approximately equal to inner diameter of the straight tubular body 21, whereby the first section 411 can be coaxially plugged into the opening 22 of the straight tubular body 21 by a certain depth. An outer thread is annularly disposed on a circumference of the second section 412 of the main body 41 to form a threaded section 42. The threaded section 42 is spaced from the first axial end of the main body 41. A regular hexagonal socket is disposed on an end face of the second axial end of the main body to form a driven section 43 in adjacency to the threaded section 42.

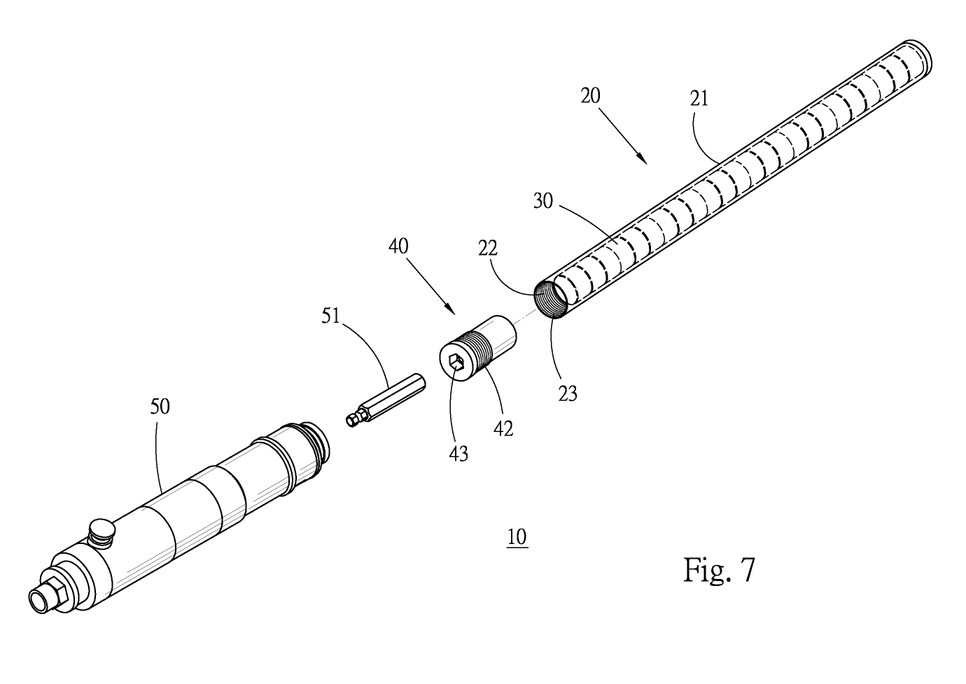

Please refer to FIG. 7. The stator assembling mechanism 10 of linear motor of the present invention is adapted to automated assembling process. To speak more specifically, the sleeve 20 provides a receiving space for the magnetic members 30. The straight tubular body 21 serves to restrict the magnetic members 30 in the internal space and keep the magnetic members 30 coaxially serially arranged and located in contact with each other. In practical assembling process, a conventional power-driven tool such as a power screwdriver 50 with a hexagonal screwdriver bit 51 can be inserted into the driven section 43 of the end piece 40 to drive and rotate the main body 41. In this case, the threaded section 42 can be easily screw-connected with the corresponding inner thread 23 to block the opening 22. At the same time, the magnetic members 30 are sealed in the internal space of the straight tubular body 21. Accordingly, the assembling process of the linear motor stator can be automated.

In comparison with the prior art, the linear motor stator assembling mechanism 10 of the present invention has smaller number of components and smaller number of varieties of components. This can reduce material cost and stock cost. More importantly, the linear motor stator assembling mechanism 10 of the present invention is adapted to automated assembling process. The sleeve 20 and the end pieces 40 can be connected and assembled with each other by means of external power tool in single assembling process. Therefore, the linear motor stator can be more conveniently assembled at higher efficiency than the prior art. Accordingly, the production efficiency can be greatly enhanced to lower manufacturing cost and increase competitive ability of the products.

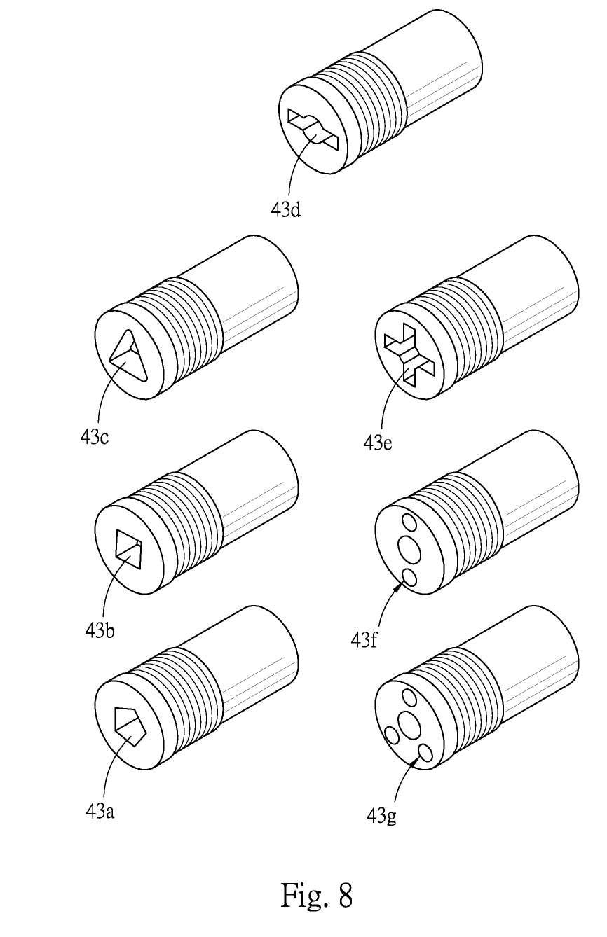

The above embodiment is only used to illustrate the present invention, not intended to limit the scope thereof. Many modifications of the above embodiments can be made without departing from the spirit of the present invention as follows:
1. The threaded section can be alternatively formed of an inner thread. In this case, outer threads are annularly formed on outer circumferences of two axial ends of the straight tubular body corresponding to the inner thread for screw-connecting therewith.
2. The driven section of the end piece is not limited to the hexagonal socket. Alternatively, the driven section can have any other regular polygonal shape. For example, as shown in FIG. 8, the driven section can be a pentagonal socket 43a, a quadrangular socket 43b, a triangular socket 43c, a straight slot 43d, a cross slot 43e or multiple symmetrical circular holes 43f, 43g. All these configurations are included in the scope of the present invention.
3. The driven section of the end piece can be alternatively a polygonal block integrally formed at the end of the main body. In this case, a drive tool such as a socket wrench can be fitted on the polygonal block to drive the end piece. The polygonal block can have a shape identical to that of any of the aforesaid sockets. That is, the polygonal block can be a regular polygonal block such as a hexagonal block, a quadrangular block, etc.

In other words, the stator assembling mechanism of linear motor that is adapted to automated assembling process of the present invention is characterized in that via a force application section, (that is, the driven section), an external power device can drive the main body to assemble the end piece with the sleeve and form the linear motor stator by one single step. All those modifications of the above embodiments should be included in the scope of the present invention.

What is claimed is:

1. A stator assembling mechanism of linear motor that is adapted to automated assembling process, comprising:
a sleeve including a straight tubular body, the straight tubular body having two axial ends each having an opening;
several magnetic members sequentially arranged and received in the straight tubular body along an axis thereof with the magnetic poles of the same polarity adjacent to each other to repel each other; and
two end pieces each having a main body, a threaded section being formed on the main body for screw-connecting with one axial end of the straight tubular body so as to block the openings of the sleeve and restrict the magnetic members in the straight tubular body, a driven section being disposed at one end of the main body, whereby via the driven section, an external power device can drive and rotate the main body to screw-connect the threaded section with the axial end of the straight tubular body so as to connect the end piece with the sleeve.

2. The stator assembling mechanism of linear motor as claimed in claim 1, wherein each magnetic member includes at least two magnetic bodies, which are arranged with the magnetic poles of different polarities adjacent to each other to attract each other.

3. The stator assembling mechanism of linear motor as claimed in claim 1, wherein each threaded section is an outer thread, inner threads being respectively annularly formed on inner circumferences of two axial ends of the straight tubular body for screw-connecting with the outer threads.

4. The stator assembling mechanism of linear motor as claimed in claim 3, wherein the threaded section is annularly disposed on a circumference of the main body in adjacency to the driven section.

5. The stator assembling mechanism of linear motor as claimed in claim 4, wherein the other end of the main body is spaced from the threaded section.

6. The stator assembling mechanism of linear motor as claimed in claim 1, wherein the driven section is disposed at the end of the main body in the form of a socket with a geometrical shape, the socket being formed on an end face of the end of the main body.

7. The stator assembling mechanism of linear motor as claimed in claim 6, wherein the driven section is disposed at the end of the main body in the form of a socket selected from a group consisting of a regular polygonal socket, a straight slot, a cross slot and multiple symmetrical circular holes.

8. The stator assembling mechanism of linear motor as claimed in claim 6, wherein the driven section has a regular hexagonal shape.

9. The stator assembling mechanism of linear motor as claimed in claim 1, wherein the driven section is a polygonal block integrally formed at the end of the main body.

10. The stator assembling mechanism of linear motor as claimed in claim 9, wherein the driven section has a polygonal shape.

11. The stator assembling mechanism of linear motor as claimed in claim 10, wherein the driven section has a regular hexagonal shape.
